(19) United States
(12) Patent Application Publication
(10) Pub. No.: US 2007/0131465 A1
(43) Pub. Date: Jun. 14, 2007

(54) Drive wheel assembly for golf bag carts

(75) Inventor: Keith Garceau, Rochester, NY (US)

Correspondence Address: BROWN & MICHAELS, PC;400 M & T BANK BUILDING, 118 NORTH TIOGA ST, ITHACA, NY, 14850, US

(73) Assignee: Acro Industries, Inc., Rochester, NY (US)

(21) Appl. No.: 11/301,225

(22) Filed: Dec. 12, 2005

(51) Int. Cl. B60K 1/00

(52) U.S. Cl. 180/65.5

(57) ABSTRACT

The drive wheel assembly for a golf bag cart preferably includes a quick connect and disconnect drive wheel shaft, a drive and steering system, and a control system. The drive wheel shaft connects to a turning fork, which supports the drive wheel on either side of the wheel hub. A double worm reduction drive is preferably used for steering the turning fork of the drive wheel. The drive and steering system also includes a hub motor located in the wheel hub, a steering motor located in the turning fork, and a remote control capacity so that the drive wheel can be steered and driven remotely. In one embodiment, the drive wheel assembly attaches to a conventional pull cart to convert it to an electric golf bag cart. The drive wheel disconnects to allow the cart to fold up in a compact way for storage in a car trunk.

### BACKGROUND OF THE INVENTION

1. Field of the Invention

The invention pertains to the field of drive wheels. More particularly, the invention pertains to a drive wheel for driving and steering a golf bag cart.

2. Description of Related Art

Drive wheel systems for golf bag carts are known in the art. Many of these systems are integral with the golf bag cart, making the entire assembly expensive and bulky.

U.S. Pat. No. 5,375,673, issued Dec. 27, 1994 to McCall et al., discloses an accessory drive unit for attachment to the central support member of a non-motorized golf bag cart. The unit includes a front wheel drive unit having a front wheel, a motor within the front wheel, control circuitry for controlling the speed and direction of rotation of the front wheel, and structure to steer the front wheel unit. The accessory unit is large and heavy.

Many of the prior art systems, including U.S. Pat. No. 5,375,673, show a drive wheel on the handle side of the golf bag cart. Conventional golf bag carts today have a third wheel on the opposite side of the cart from the handle, so these old suggestions for a drive wheel on the handle side of the cart are apparently obsolete and not likely to return to practicality.

Remote control devices for electric golf bag carts are also known in the art. Many remote devices allow the user only to drive the cart forward or backward, requiring the user to turn the cart manually. Other devices additionally allow turning, but do not provide any further control features. To bring the cart out of a turn, the user must steer back in the other direction to straighten out the wheel.

### SUMMARY OF THE INVENTION

The drive wheel assembly for a golf bag cart preferably includes a quick connect and disconnect drive wheel shaft, a drive and steering system, and a control system. The drive wheel shaft connects to a turning fork, which supports the drive wheel on either side of the wheel hub. A double worm reduction drive is preferably used for steering the turning fork of the drive wheel. The drive and steering system also includes a hub motor located in the wheel hub, a steering motor located in the turning fork, and a remote control capacity so that the drive wheel can be steered and driven remotely. In one embodiment, the drive wheel assembly attaches to a conventional pull cart to convert it to an electric golf bag cart. The drive wheel disconnects to allow the cart to fold up in a compact way for storage in a car trunk.

In a first embodiment, the drive wheel assembly for a golf bag cart includes at least one drive wheel, a drive wheel shaft, a turning fork, a turning mechanism, and a control system. A drive motor is built into the drive wheel. The drive wheel shaft connects the drive wheel to the golf bag cart. The turning fork extends from the drive wheel shaft and mounts the drive wheel. The turning mechanism is located in the turning fork and includes a steer motor driving gearing to rotate the turning fork with respect to the drive wheel shaft. The control system receives commands from a user and controls the speed and direction of the drive motor and the steer motor.

The turning mechanism preferably includes a motor worm driven by the steer motor, a worm wheel driven by the motor worm, a sector worm driven by the worm wheel, and a steering sector. Movement of the sector worm on the steering sector rotates the turning fork and the drive wheel with respect to the shaft. The assembly preferably includes a quick connect and disconnect feature for attaching and detaching the shaft to the golf bag cart.

The control system preferably includes a receiver-controller-power unit including a microprocessor for processing commands from the user. The microprocessor preferably measures the turning interval during a turn indicated by the user and uses the turning interval to straighten the drive wheel automatically without a user command. The microprocessor preferably ramps the current up and down to the drive motor to provide a smooth start and stop to the cart. The control system preferably includes a runaway prevention feature, wherein the drive motor stops running if the microprocessor receives no commands from the user for a predetermined period of time. The control system preferably includes a free-wheeling mode, where the drive motor and the turning mechanism are disengaged such that there is minimal drag on the drive wheel from the drive motor, the steer motor, and the turning mechanism when the user manually drives and steers the cart. The microprocessor preferably directs a varying voltage to the drive motor such that the drive wheel moves at the same speed regardless of the slope or smoothness of the terrain. The receiver-controller-power unit preferably includes a battery and a battery recharger. The battery recharger stores energy from braking in the battery. The RCPU preferably includes a speed knob to regulate the drive speed of the assembly.

The control system preferably includes a transmitter unit having a plurality of buttons for receiving inputs from the user.

The drive wheel shaft is preferably mounted on the side of the golf bag cart opposite the handle of the golf bag cart.

In a second embodiment, the drive wheel assembly for a golf bag cart includes at least one drive wheel, a drive wheel shaft, a quick connect and disconnect feature, a turning fork, and a turning mechanism. A drive motor is built into the drive wheel. The drive wheel shaft connects the drive wheel to the golf bag cart. The quick connect and disconnect feature attaches and detaches the drive wheel shaft to the golf bag cart. The turning fork extends from the drive wheel shaft and mounts the drive wheel. The turning mechanism is located in the turning fork and includes a steer motor driving gearing to rotate the turning fork with respect to the drive wheel shaft.

In a third embodiment, the drive wheel assembly for a golf bag cart includes at least one drive wheel, a drive motor to drive the drive wheel, a turning mechanism including a steer motor to rotate the drive wheel with respect to the golf bag cart, and a drive position switch. When the drive position switch is in a first position, the drive wheel drives in a leading position with respect to the cart. When the drive position switch is in a second position, the drive wheel drives in a trailing position with respect to the cart.

In a fourth embodiment, the drive wheel assembly for a golf bag cart includes at least one drive wheel, a drive motor to drive the drive wheel, a turning mechanism including a steer motor to rotate the drive wheel with respect to the golf bag cart, and a control system including a microprocessor for receiving commands from a user and controlling the speed and direction of the drive motor and the steer motor. The microprocessor measures a turning interval during a turn indicated by the user and uses the turning interval to straighten the drive wheel automatically without a user command.

In a fifth embodiment, the method converts a non-motorized golf bag cart having a front wheel and a pair of balance wheels to a motorized golf bag cart. The method includes removing the front wheel from the non-motorized golf cart. The method also includes mounting a drive wheel assembly including at least one drive wheel to the non-motorized golf cart. The method further includes supplying power to a drive motor and a steer motor for driving and steering the drive wheel. The method also includes supplying a control system for allowing a user to input drive and steer commands to drive and steer the motorized golf bag cart.

### BRIEF DESCRIPTION OF THE DRAWINGS

FIG. 1 shows a top view of a drive wheel unit in an embodiment of the present invention.

FIG. 2 shows a steer motor and gearing for steering a drive wheel in an embodiment of the present invention.

FIG. 3 shows a schematic top view of a drive wheel unit of the present invention showing a preferred location of the steering mechanism.

FIG. 4 shows a side view of the drive wheel unit of FIG. 3.

FIG. 5 shows a schematic of a drive wheel assembly attached to a golf bag cart in an embodiment of the present invention.

FIG. 6 shows a transmitter unit in an embodiment of the present invention.

### DETAILED DESCRIPTION OF THE INVENTION

Features of a preferred drive wheel assembly include a drive motor in the drive wheel, a sector and worm steer motor in the turning fork, a quick connect and disconnect mechanism of the drive wheel assembly, a receiver-controller-power unit (RCPU), and a remote transmitter unit. The drive motor in the drive wheel allows for a compact drive wheel assembly. The steer motor and gearing in the turning fork also allows for a compact drive wheel assembly. The quick connect and disconnect mechanism allows the drive wheel assembly to easily convert a conventional non-motorized golf bag cart into a motorized golf bag cart and to be removed for easy storage of the drive wheel assembly and golf bag cart. The RCPU preferably includes a microprocessor for advanced control of the motorized golf bag cart.

Structure

Locating the drive motor in the drive wheel has advantages in the remote controlling and general operating and handling of the device. It also makes the assembly compact, lightweight, and durable in the golf course environment, which includes exposure to rain, wet grass, standing water, sand, dirt, and mud. Although any drive motor built in a drive wheel may be used within the spirit of the present invention, the drive motor is preferably a hub drive motor. The drive motor is preferably a reduction drive.

A turning fork preferably holds the drive wheel. The steer mechanism, including a small steer motor, is preferably housed in the turning fork. The steer motor drives a worm gear that causes the fork to turn around a sector of a worm wheel, housed within the turning fork, relative to the connection device, for steering purposes. The worm/worm wheel reduction drive for the steering has the advantage that the gearing can not get bumped out of alignment if the cart hits a rock or other obstacle on the course.

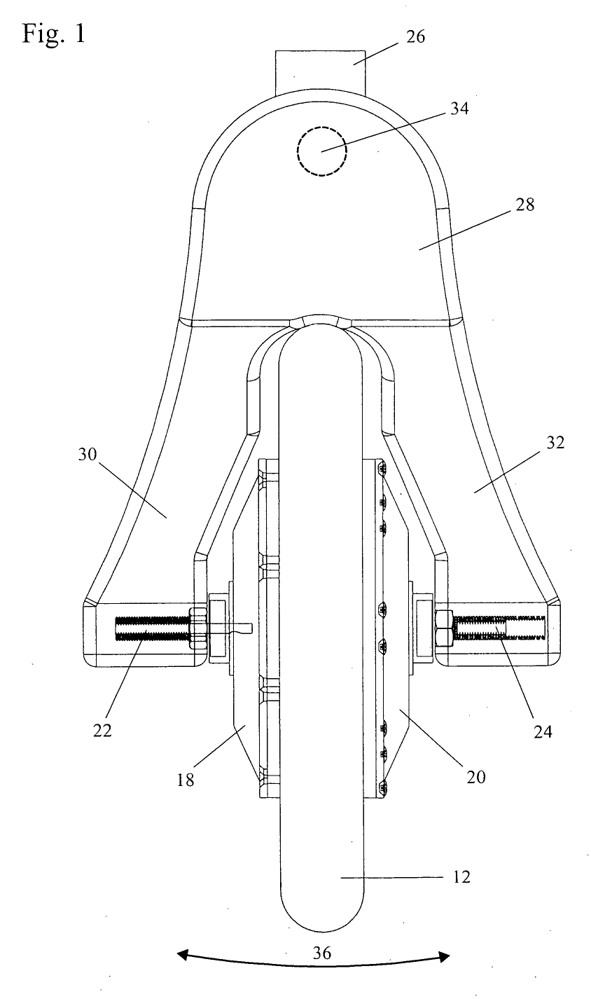

Referring to FIG. 1, a preferred drive wheel unit of the present invention includes a shaft 26 attached to a turning fork 28, which supports the drive wheel 12. The drive wheel 12 is supported by a pair of tines 30, 32 extending from the turning fork 28 at the pair of axles 22, 24 extending from the pair of hubs 18, 20 located on the sides of the drive wheel 12. The drive motor to drive the drive wheel 12 is preferably located in the wheel between or incorporated with the hubs 18, 20. The turning fork 28 turns around a pivot 34 to turn the assembly left or right along the direction 36 with respect to the shaft 26.

A double worm reduction drive is preferably used for steering the turning fork of the drive wheel. The double worm drive in series provides a large reduction which allows a compact motor running at 3000 to 4000 revolutions per minute (RPM) to be used as the steering motor to produce the steering force that is necessary to turn the turning fork and drive wheel. Although a full worm wheel may be used for the final worm wheel, the final worm wheel is preferably a sector to reduce size and weight, because the turning fork only turns a limited range to the right and to the left to accomplish steering. In the double worm drive, the steering motor drives a motor worm, which drives a worm wheel, which in turn drives a sector worm, which meshes with the steering sector gear to move the turning fork right and left.

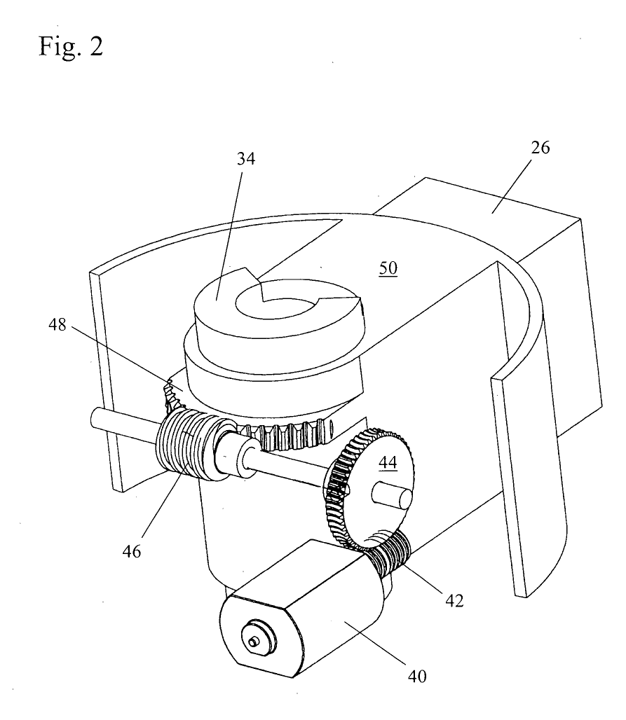

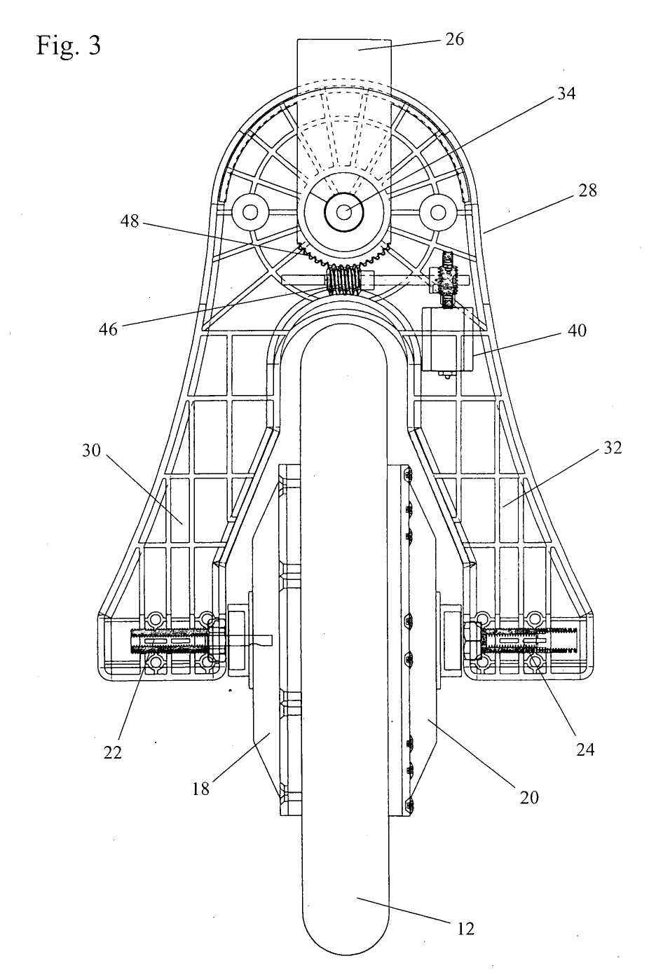

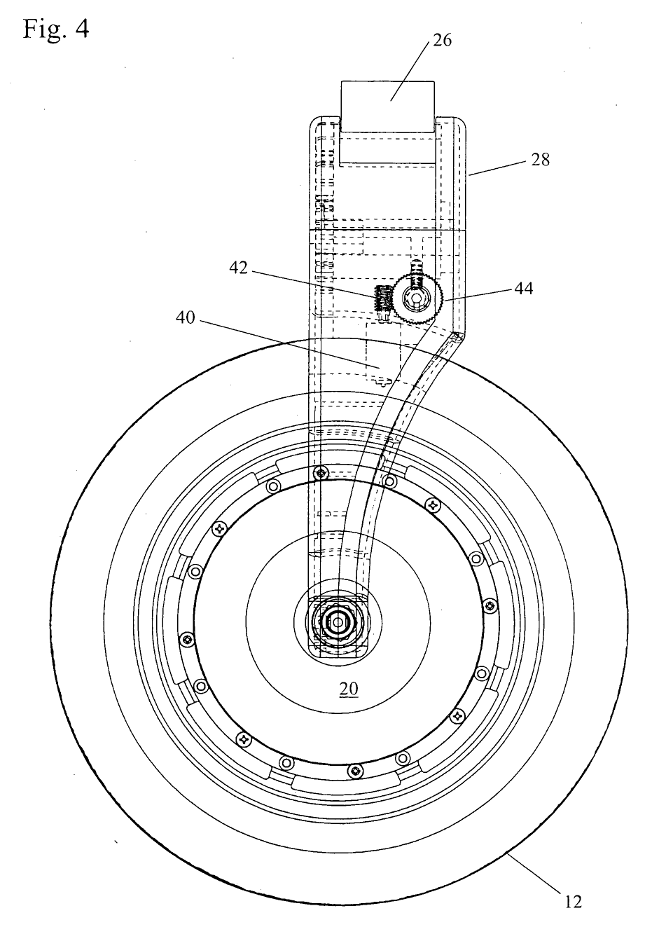

Referring to FIG. 2 through FIG. 4, a preferred steering mechanism for a drive wheel assembly of the present invention is located in the turning fork 28 of FIG. 1. The steering mechanism includes a steering motor 40 driving a motor worm 42, which drives a worm wheel 44 coupled to a second worm 46. The second worm 46 rotates causing the steering sector 48 to rotate the shaft 26. The shaft 26, being fixed to the cart and attached to base 50 causes the fork to turn about a pivot 34. Hence the drive wheel 12 turns with respect to the drive shaft 26.

The invention is readily adapted to a disconnectable wheel and may use various connect and disconnect systems to make it fit existing carts. The drive wheel assembly may be attached to an existing cart after removing a detachable non-driving front wheel from the golf bag cart. The drive wheel unit may insert into a mounting hole or attach to an existing shaft on the cart. The drive wheel assembly may alternatively include a foldable wheel rather than a detachable wheel within the spirit of the present invention.

Although a drive wheel assembly of the present invention offers many advantages as an integral or permanent component of an electric golf bag cart, the quick connect and disconnect feature of a drive unit of the present invention allows the drive wheel assembly to be used in combination with any conventional golf bag pull cart to convert the pull cart into an electric golf bag cart. The quick connect and disconnect preferably includes a friction fit in a tube and a wedge or toggle that pulls to make the male part of it more compact for coupling and that increases the part's diameter to provide a snug fit within the tube.

A drive wheel unit of the present invention is preferably located on the side of the golf bag cart opposite the handle. In other words, the pair of balance wheels found on a conventional cart are preferably located between the drive wheel and the conventional handle of the golf bag cart. The drive wheel replaces the front wheel found on a conventional three-wheel push golf bag cart.

A drive wheel assembly of the present invention preferably includes a transmitter unit and a receiver-controller-power unit (RCPU). The transmitter unit includes a keypad and a transmitter. The RCPU includes a receiver to receive the signal from the remote transmitter, the battery to supply power to the drive motor and steer motor, a circuit board, and a microprocessor to interpret the received transmission and determine the currents sent to the drive motor and the steer motor. The RCPU also includes a battery charger, which is part of the circuit board. The RCPU is preferably mounted on the handle side of the cart and wired to the drive wheel unit. The transmitter unit for the user to drive the golf bag cart may be mounted along with the RCPU when not in use. The transmitter unit is preferably a wireless remote controller. The battery charger is built into the RCPU so that the user does not need a separate battery charger. For charging the battery, the RCPU is plugged into a circuit.

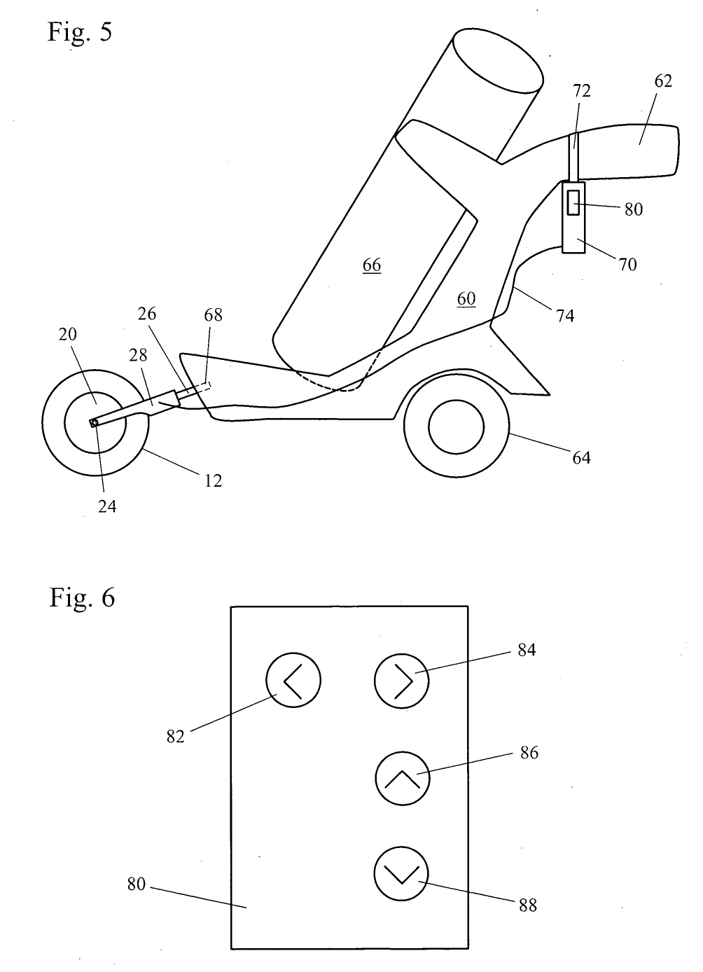

Referring to FIG. 5, a drive wheel 12 of the present invention preferably replaces the front wheel of a non-motorized golf bag cart 60. The golf bag cart 60 is preferably a conventional three-wheel cart and may be foldable or non-foldable. The front wheel is located on the end of the golf bag cart 60 opposite the handle 62 in a conventional three-wheel golf bag cart 60. The pair of balance wheels 64 are located closer to the handle 62. The golf bag cart 60 is designed to hold at least one golf bag 66. The conventional front wheel of the golf bag cart 60 is removed from the front wheel mount position 68, and the shaft 26 of the drive wheel assembly is mounted in the front wheel mount position 68 to convert the non-motorized golf bag cart into a motorized golf bag cart. A variety of mounting systems may be used to customize the mount for mount positions 68 of various commercial push-type golf bag carts. The RCPU 70, preferably hung from the handle 62 of the golf bag cart 60 by a hook, strap, clamp, or other hanging means 72, supplies power to the steer motor and the drive motor through a preferably disconnectable wire 74. When not in use, the transmitter unit 80 is preferably mounted on the RCPU 70.

Although a wheel assembly of the present invention preferably includes a single drive wheel, a dual wheel may also be used within the spirit of the present invention. In a dual wheel embodiment, one drive motor is preferably used to operate the pair of dual wheels.

Control System

A control system of the present invention preferably includes a transmitter unit with a keypad for receiving inputs from the user and transmitting them to a receiver in the receiver-controller-power unit (RCPU). A microprocessor converts the transmissions into actions on the drive motor and the steer motor. The input to the RCPU is through an electronic security device, or fob. The RCPU has an on-off switch and includes the microprocessor. A speed dial on the RCPU allows the user to set a desired speed for the drive wheel. The desired speed is preferably the normal walking speed of the user. The user may also override the speed dial and intervene and control the speed using the transmitter unit while driving the cart.

The microprocessor accomplishes steering control and gives the control system many capacities that present motorized golf bag carts lack. Preferably, the user of a drive wheel assembly of the present invention initially sets the straight-ahead direction and indicates to the controller that that is what is required. Then whenever the user turns the cart by holding down the turn button and releases the turn button, the microprocessor straightens out the steering in the new direction that has been achieved. In other words, the user controls the steering by pressing a button and holding it for long enough to turn to the desired new direction and then releases it, whereupon the steering system automatically reverts back to the center position for proceeding straight ahead in the new direction.

In one embodiment, the microprocessor notices how long the cart spent turning right and then spends the same amount of time steering back to the left to bring the steering wheel back to a straight-ahead position after a turn. In another embodiment, the microprocessor counts the number of rotations of the worm wheel or sector worm during the turn and then counts the number of rotations in the opposite direction to return to a straight-ahead position. In an alternate embodiment, the steering system has an internal straight-ahead position set point to which it returns whenever the user finishes inputting a turn command.

Although the transmitter unit may have numerous input buttons on the keypad, four input buttons are preferred, sufficient, and adequate to drive and steer the drive wheel: forward, reverse, right, and left. The user uses the transmitter unit to indicate a straight-ahead position, a desire to start the cart moving forward, increase or decrease forward speed, turn the cart left or right, stop the cart, or start the cart moving backward.

Referring to FIG. 6, a preferred transmitter 80 for driving and turning a drive wheel of the present invention includes a left button 82, a right button 84, a forward button 86, and a reverse button 88. In a preferred embodiment of the present invention, the same input to the transmitter produces different responses depending on whether the cart is moving or standing still.

When the drive motor is not running and the cart is stationary, the following commands may be entered. Pressing the left button 82 turns the wheel assembly in the direction of a left turn. Pressing the right button 84 turns the wheel assembly in the direction of a right turn. Simultaneously pressing and releasing the left button 82 and the reverse button 88 tells the microprocessor that the wheel assembly is in a straight-ahead position. To set the straight-ahead position, the user presses the left and right buttons to jog the wheel assembly left or right until it is in a straight-ahead position. The user then simultaneously presses the left and reverse buttons. This causes the transmitter to transmit a signal received by the receiver, and the microprocessor understands the current steering position to be straight ahead. Pressing and releasing the forward button 86 causes the drive motor to start running and the drive wheel to start moving in a forward direction. Pressing the reverse button 88 causes the drive motor to start running and the drive wheel to start moving in a reverse direction. Since reverse driving is typically only needed for short periods of time, such as backing the cart away from a tree or other obstacle, the user holds down the reverse button 88 for as long as reverse is necessary, and releasing the reverse button 88 causes the cart to stop moving.

When the drive motor is running and the cart is moving, the following commands may be entered. Pressing and holding the left button 82 increasingly turns the wheel assembly toward a left turn. Pressing and holding the right button 84 increasingly turns the wheel assembly toward a right turn. Upon release of the left button 82 or the right button 84, the control system automatically straightens out the cart by moving the wheel assembly back to the straight-ahead position. Pressing and holding the forward button 86 causes the drive motor to increase the speed of the drive wheel. Pressing and holding the reverse button 88 causes the drive motor to decrease the speed of the drive wheel. Pressing and releasing either the forward button 86 or the reverse button 88 causes the drive motor to stop running, thereby stopping the golf bag cart.

The control system preferably provides a soft start and a soft stop in that the microprocessor directs increasing power to the drive wheel for a gentle start-up and regenerative braking to bring the cart to a gentle stop. The microprocessor slowly ramps the current up and down rather than stepping the current between on and off. This eliminates any abrupt speed changes that might make the user lack confidence in the ability of the assembly to control the movement of the golf bag cart.

Some users may prefer to drive the cart with the drive wheel leading, while others may prefer to drive the cart with the drive wheel trailing. In a preferred embodiment, the drive wheel may either lead or trail depending on the user's preference in driving across the golf course. The control system includes a user-selectable switch on the RCPU for whether the drive wheel leads in the travel of the cart or trails. Also, the user may prefer to have the drive wheel work in a trailing direction going uphill but in a leading direction while traveling on more level ground. If the cart approaches a steep hill and the drive wheel is forward, the weight is shifted to the rear wheels and may cause the drive wheel to lose traction. In that circumstance the user turns the cart around, which may be done manually or with control buttons on the fob and with a directional switch on the controller so that the cart proceeds up the hill with the drive wheel trailing, where it has better traction. The logic of the control system is preferably user-friendly. Whether the drive wheel is leading or trailing, when the user indicates a right or left turn, the microprocessor complies in a way that makes sense to the user.

The microprocessor preferably performs load compensation or load management so that the cart goes the same speed uphill and downhill as it goes on level ground, even though a current adjustment is necessary to make this possible. The drive system feeds the motor with the proper voltage to have the power to maintain the same speed regardless of the slope or traction of the terrain. In an alternative embodiment, the drive motor is a constant velocity motor so that it tends to go the same speed uphill and downhill. If desired, the user manually adjusts the speed of the cart on an incline using the transmitter unit.

The cart may go downhill with the drive wheel leading or trailing. With the drive wheel trailing, where its traction is reduced, adequate traction remains under normal conditions to stop the cart and brake the cart from going too fast down the hill. The cart preferably also regeneratively brakes while going downhill. Since the battery recharger is housed in the RCPU, the system is designed so that the energy accumulated from braking the cart when going downhill or to slow or stop the cart is used to recharge the battery. This feature conserves energy and increases the time between recharges of the battery.

The controller also preferably includes a free-wheeling switch to convert to a free-wheeling mode. If for some reason the battery has lost its charge or the user failed to charge it, the drive wheel assembly can switch into free-wheeling mode and allow the user to push and drive the cart around manually. The drive wheel assembly is made of lightweight materials and adds a minimal weight to the golf bag cart so that it does not become a burden to manually operating the cart in the free-wheeling mode. In the free-wheeling mode, there is minimal drag from the motors or the steering system. The cart operates as it would with a non-motorized front wheel, where steering is done manually by pressing the handle down to lift the drive wheel off the ground and rotating the cart around the balance wheels.

The code used for the transmitter is preferably a known type of radio frequency (RF) code called rolling code. It involves many choices so that it is applied to a multitude of carts without one user's remote having an effect on another user's cart. In practice, the fobs are taught to respond to the transmitters such that controllers for other golf bag carts do not respond to that fob. If the fob is lost, the owner gets a new one and teaches it to cooperate with the controller.

The control system also preferably includes a runaway prevention feature that stops the cart in the absence of a signal from the transmitter after a pre-determined interval of time, distance, or gear rotations. The interval is preferably set for no longer than the time, distance, or gear rotations that it takes the user to walk from the tee to his longest drive so that it is rare that any activity is interrupted by having the cart turn off based on its timer. In one embodiment, the interval is three minutes. This feature prevents the cart from wandering too far off or getting out of range, while the user is hunting for a lost ball or is otherwise distracted. The feature requires the user to input a new command after the time has expired.

A drive wheel assembly of the present invention is preferably designed to be lightweight, compact, and energy-efficient so that the cart goes two full rounds of golf on a single battery charge.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A drive wheel assembly for a golf bag cart comprising:
at least one drive wheel having a drive motor built into the drive wheel;
a drive wheel shaft for connecting the drive wheel to the golf bag cart;
a turning fork extending from the drive wheel shaft and mounting the drive wheel;
a turning mechanism in the turning fork comprising a steer motor driving gearing to rotate the turning fork with respect to the drive wheel shaft; and
a control system for receiving commands from a user and controlling the speed and direction of the drive motor and the steer motor.

2. The assembly of claim 1, wherein the turning mechanism further comprises:
a motor worm driven by the steer motor;
a worm wheel driven by the motor worm;
a sector worm driven by the worm wheel; and
a steering sector, wherein movement of the sector worm on the steering sector rotates the turning fork and the drive wheel with respect to the shaft.

3. The assembly of claim 1 further comprising a quick connect and disconnect feature for attaching and detaching the shaft to the golf bag cart.

4. The assembly of claim 1, wherein the control system further comprises a receiver-controller-power unit comprising a microprocessor for processing commands from the user.

5. The assembly of claim 4, wherein the microprocessor measures a turning interval during a turn indicated by the user and uses the turning interval to straighten the drive wheel automatically without a user command.

6. The assembly of claim 4, wherein the microprocessor ramps a current up and down to the drive motor to provide a smooth start and a smooth stop to the cart.

7. The assembly of claim 4, wherein the control system further comprises a runaway prevention feature, wherein the drive motor stops running if the microprocessor receives no commands from the user for a predetermined period of time.

8. The assembly of claim 4, wherein the control system further comprises a free-wheeling mode, wherein the drive motor and the turning mechanism are disengaged such that there is minimal drag on the drive wheel from the drive motor, the steer motor, and the turning mechanism when the user manually drives and steers the cart.

9. The assembly of claim 4, wherein the microprocessor directs a varying voltage to the drive motor such that the drive wheel moves at the same speed regardless of a slope of terrain or a smoothness of terrain.

10. The assembly of claim 4, wherein the receiver-controller-power unit further comprises a battery and a battery recharger and the battery recharger stores energy from braking in the battery.

11. The assembly of claim 4, wherein the receiver-controller-power unit further comprises a speed knob to regulate the drive speed of the assembly.

12. The assembly of claim 1, wherein the control system further comprises a transmitter unit having a plurality of buttons for receiving inputs from the user.

13. The assembly of claim 1, wherein the drive wheel shaft is mounted on a side of the golf bag cart opposite a handle of the golf bag cart.

14. A drive wheel assembly for a golf bag cart comprising:
at least one drive wheel having a drive motor built into the drive wheel;
a drive wheel shaft for connecting the drive wheel to the golf bag cart;
a quick connect and disconnect feature for attaching and detaching the drive wheel shaft to the golf bag cart;
a turning fork extending from the drive wheel shaft and mounting the drive wheel; and
a turning mechanism in the turning fork comprising a steer motor driving gearing to rotate the turning fork with respect to the drive wheel shaft.

15. A drive wheel assembly for a golf bag cart comprising:
at least one drive wheel;
a drive motor to drive the drive wheel;
a turning mechanism comprising a steer motor to rotate the drive wheel with respect to the golf bag cart; and
a drive position switch;
wherein when the drive position switch is in a first position, the drive wheel drives in a leading position with respect to the cart, and wherein when the drive position switch is in a second position, the drive wheel drives in a trailing position with respect to the cart.

16. A drive wheel assembly for a golf bag cart comprising:
at least one drive wheel;
a drive motor to drive the drive wheel;
a turning mechanism comprising a steer motor to rotate the drive wheel with respect to the golf bag cart; and
a control system including a microprocessor for receiving commands from a user and controlling the speed and direction of the drive motor and the steer motor;
wherein the microprocessor measures a turning interval during a turn indicated by the user and uses the turning interval to straighten the drive wheel automatically without a user command.

17. A method of converting a non-motorized golf bag cart having a front wheel and a pair of balance wheels to a motorized golf bag cart comprising the steps of:
a) removing the front wheel from the non-motorized golf cart;
b) mounting a drive wheel assembly comprising at least one drive wheel to the non-motorized golf cart;
c) supplying power to a drive motor and a steer motor for driving and steering the drive wheel; and
d) supplying a control system for allowing a user to input drive and steer commands to drive and steer the motorized golf bag cart.
